(19) United States
(12) Patent Application Publication
(10) Pub. No.: US 2018/0030604 A1
(43) Pub. Date: Feb. 1, 2018

(54) CARBON DIOXIDE-REDUCTION DEVICE

(71) Applicant: FUJITSU LIMITED, Kawasaki-shi (JP)

(72) Inventors: Toshio MANABE, Atsugi (JP); Yoshihiko Imanaka, Atsugi (JP)

(73) Assignee: FUJITSU LIMITED, Kawasaki-shi (JP)

(21) Appl. No.: 15/652,996

(22) Filed: Jul. 18, 2017

(30) Foreign Application Priority Data
Aug. 1, 2016 (JP) 2016-151427

(51) Int. Cl. C25B 9/08; B01D 53/02; C25B 1/00; C25B 13/08; C25B 3/04

(52) U.S. Cl. CPC C25B 9/08; C25B 13/08; C25B 3/04; C25B 1/003; B01D 53/02; B01D 2257/504; B01D 2253/102; B01D 2253/106; B01D 2253/1122; B01D 2253/25

(57) ABSTRACT

A carbon dioxide-reduction device including an anode, a liquid-retaining film capable of retaining an electrolytic solution, a proton-permeable membrane, and a cathode, wherein the cathode includes a metal-containing member and an adsorbent, where the metal-containing member includes a metal capable of reducing carbon dioxide and has pores through which carbon dioxide can pass in a thickness direction of the metal-containing member, and the adsorbent is capable of adsorbing carbon dioxide, and is disposed at a surface of the metal-containing member at a side of which the proton-permeable membrane is present.

### CROSS-REFERENCE TO RELATED APPLICATION

This application is based upon and claims the benefit of priority of the prior Japanese Patent Application No. 2016-151427, filed on Aug. 1, 2016, the entire contents of which are incorporated herein by reference.

### FIELD

The present disclosure relates to a carbon dioxide-reduction device.

### BACKGROUND

Since global warming was recognized, how to reduce carbon dioxide released into the atmosphere as a result of industrial activities has been an important challenge.

As a method for reducing carbon dioxide in the atmosphere, a technique of artificial photosynthesis has been recently attracted attentions. The technique of artificial photosynthesis is a technique for reducing carbon dioxide by using energy of sun light to convert the carbon dioxide into a usable organic compound. In the artificial photosynthesis, electrons and protons are generated by applying sun light to a photo-excitable material placed on an anode in a tank filled with an electrolytic solution. Then, the generated electrons and protons are sent to a reduction catalyst placed on a cathode and are allowed to react with carbon dioxide to generate carbon monoxide or an organic compound. The reaction performed at the side of the cathode is a type of an electrolytic reduction. On the catalyst of the cathode, carbon dioxide is reacted with two electrons and two protons in stages to reduce the carbon dioxide to a material having high usefulness, such as formic acid, carbon monoxide, formaldehyde, methanol, and methane.

In a typical method of electrolytic reduction, an electrochemical cell including a working electrode, a counter electrode, and a tank is used (see, for example, International Publication No. WO2011/132375).

### SUMMARY

According to one aspect of the present disclosure, a carbon dioxide-reduction device includes:

an anode;

a liquid-retaining film capable of retaining an electrolytic solution;

a proton-permeable membrane; and

a cathode,
wherein the cathode includes a metal-containing member and an adsorbent,
where the metal-containing member includes a metal capable of reducing carbon dioxide and has pores through which carbon dioxide can pass in a thickness direction of the metal-containing member, and
the adsorbent is capable of adsorbing carbon dioxide, and is disposed at a surface of the metal-containing member at a side of which the proton-permeable membrane is present.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic cross-sectional view illustrating one example of a cathode;

FIG. 2 is a schematic cross-sectional view illustrating another example of the cathode;

FIG. 3 is a schematic view illustrating a state of a reduction reaction of carbon dioxide at the cathode;

FIG. 4A is a schematic cross-sectional view illustrating one example of a carbon dioxide-reduction device;

FIG. 4B is a left-side view illustrating one example of the carbon dioxide-reduction device;

FIG. 5A is a schematic cross-sectional view illustrating another example of the carbon dioxide-reduction device;

FIG. 5B is a left-side view illustrating another example of the carbon dioxide-reduction device;

FIG. 6 depicts CO₂ adsorption isotherms of the samples of Experiment Examples 1 and 2;

FIG. 7 is a schematic exploded view illustrating the carbon dioxide-reduction device produced in Example 1; and

FIG. 8 depicts cyclic voltammograms of the devices of Example 1 and Comparative Example 1.

### DESCRIPTION OF EMBODIMENTS

### (Carbon Dioxide-Reduction Device)

The disclosed carbon dioxide-reduction device includes an anode, a liquid-retaining film, a proton-permeable membrane, and a cathode, and may further include other members according to the necessity.

In electrolytic reduction of carbon dioxide, it is important to retain carbon dioxide on or above an electrode also serving as a catalyst, and to efficiently supply carbon dioxide to a reaction field and collect a generated product from the reaction field in order to enhance an efficiency of the reaction.

The techniques existing in the art however are not sufficient in terms of retention of carbon dioxide on or above the electrode, and in terms of efficiency for supplying carbon dioxide to a reaction field and collection of the generated product from the reaction field.

The present disclosure has an object to provide a carbon dioxide-reduction device, which is capable of retaining carbon dioxide on or above an electrode, and efficiently supplying carbon dioxide to a reaction field and collecting a generated product from the reaction field.

The carbon dioxide-reduction device of the present disclosure can solve the above-described various problems existing in the art, and can provide a carbon dioxide-reduction device, which is capable of retaining carbon dioxide on or above an electrode, and efficiently supplying carbon dioxide to a reaction field and collecting a generated product from the reaction field.

### <Anode>

The anode is not particularly limited and may be appropriately selected depending on the intended purpose.

Examples of a material of the anode in typical electrolytic reduction performed by electrically conducting between the anode and the cathode using an external power source include Pt.

Meanwhile, examples of a material of the anode in electrolytic reduction of carbon dioxide performed by applying light to the anode (so-called artificial photosynthesis) include photo-excitable materials and multi-junction semiconductors capable of performing oxidative degradation of water.

The anode is preferably a plate-shaped body having pores through which gas can pass in a thickness direction of the body. Since the anode has the above-described structure, oxygen generated at the anode can be released from the device through the pores. Therefore, oxygen in the form of air bubbles is prevented from depositing on a surface of the anode, otherwise the deposited oxygen on the surface of the anode inhibits oxidative degradation of water.

### <Liquid-Retaining Film>

The liquid-retaining film is not particularly limited and may be appropriately selected depending on the intended purpose, as long as the liquid-retaining film is capable of retaining an electrolytic solution. Examples of the liquid-retaining film include layered absorbent materials. The layered absorbent materials are not particularly limited and may be appropriately selected depending on the intended purpose. Examples of the layered absorbent materials include layers porous bodies.

A commercial product can be used as the liquid-retaining film. Examples of the commercial product include a high performance porous plate “UNIVEKS SB” available from UNITIKA LTD. The porous plate is an absorbent porous plate formed of polyester fibers.

A shape and size of the liquid-retaining film are not particularly limited and may be appropriately selected depending on the intended purpose.

### <Proton-Permeable Membrane>

For example, the proton-permeable membrane is sandwiched between the liquid-retaining film and the cathode.

The proton-permeable membrane is configured to prevent an electrolytic solution retained in the liquid-retaining film from being in contact with the cathode.

The proton-permeable membrane is not particularly limited and may be appropriately selected depending on the intended purpose, as long as the proton-permeable membrane is a proton-permeable membrane through which substantially only protons are passed and other materials cannot pass. Examples of the proton-permeable membrane include NAFION (registered trademark).

Note that, NAFION is a perfluorocarbon material composed of a hydrophobic TEFLON (registered trademark) skeleton formed of carbon-fluorine and a perfluoro side-chain having a sulfonic acid group. Specifically, NAFION is a copolymer of tetrafluoroethylene and perfluoro[2-(fluorosulfonylethoxy)propylvinyl ether.

### <Cathode>

The cathode includes at least a metal-containing member and an adsorbent, and may further include other members according to the necessity.

### <<Metal-Containing Member>>

A material, shape, size and structure of the metal-containing member are not particularly limited and may be appropriately selected depending on the intended purpose, as long as the metal-containing member is a member, which includes a metal capable of reducing carbon dioxide at a surface of the member, and has pores through which carbon dioxide can pass in a thickness direction of the member.

Reduction of carbon dioxide using the metal-containing member typically occurs when the metal-containing member is electrically conducted. As a result of the reduction, carbon dioxide is turned into a material of high usefulness, such as formic acid, carbon monoxide, formaldehyde, methanol, and methane.

The metal is not particularly limited and may be appropriately selected depending on the intended purpose. The metal is preferably copper, silver, gold, zinc, or indium in view of an ability of performing multielectron reduction of carbon dioxide.

A shape of the metal-containing member is not particularly limited and may be appropriately selected depending on the intended purpose. Examples of the shape include a plate shape.

A structure of the metal-containing member is not particularly limited and may be appropriately selected depending on the intended purpose. For example, the structure may be a mesh formed by weaving the metal in the form of lines, or a drilled plate (e.g., punched metals by metal punching).

Shapes of the pores are not particularly limited and may be appropriately selected depending on the intended purpose. The shapes may be specific shapes or irregular shapes.

A size of each of the pores is not particularly limited and may be appropriately selected depending on the intended purpose.

Since the metal-containing member has pores, formic acid, carbon monoxide, formaldehyde, methanol, or methane generated in the cathode can be released from the device through the pores, and therefore a generated product can be efficiently collected. Since the metal-containing member has the pores, moreover, carbon dioxide is easily supplied to a reaction field of the cathode.

### <<Adsorbent>>

The adsorbent is disposed at a surface of the metal-containing member.

The adsorbent is capable of adsorbing carbon dioxide.

The adsorbent is preferably disposed at a surface of the metal-containing member at the side where the proton-permeable membrane is present.

Since the adsorbent is disposed at the surface of the metal-containing member, carbon dioxide is present at a high concentration at the surface of the metal-containing member, which is a reaction field where reduction of carbon dioxide is performed. As a result, a reduction efficiency of carbon dioxide by the metal-containing member can be improved.

The adsorbent is not particularly limited and may be appropriately selected depending on the intended purpose, as long as the adsorbent is capable of adsorbing carbon dioxide. The adsorbent is preferably activated carbon, carbon nanotubes, mesoporous silica, or a porous metal complex in view of an excellent ability of adsorbing carbon dioxide. Moreover, the adsorbent preferably has conductivity in view of excellent electron transmission necessary for reduction. The activated carbon and the carbon nanotubes have conductivity, and some types of the porous metal complex have conductivity.

The adsorbent preferably has a carboxyl group or a hydroxyl group inside pores of the adsorbent because compatibility to an electrolytic solution is improved. For example, the carboxyl group and the hydroxyl group can be formed by treating the adsorbent with acid (e.g., mixed acid).

The adsorbent preferably includes metal particles at surfaces of grains of the adsorbent. Since the metal particles are present at the surface of the adsorbent, efficiency of transmission of electrons from the metal-containing member to the adsorbent is improved. Examples of a material of the metal particles include copper, silver, gold, zinc, and indium.

### —Activated Carbon—

The activated carbon is not particularly limited and may be appropriately selected depending on the intended purpose.

A specific surface area of the activated carbon is not particularly limited and may be appropriately selected depending on the intended purpose. The specific surface area is preferably from 1,000 m²/g to 2,500 m²/g, and more preferably from 1,200 m²/g to 2,000 m²/g.

For example, the specific surface area can be determined by measuring a nitrogen adsorption isotherm using a specific surface area and pore size distribution measuring device (BELSORP-mini, available from MicrotracBEL Corp.), and analyzing according to the BET method.

The activated carbon may be produced for use or selected from commercial products. Examples of the commercial products include spherical activated carbon TAIKO Q (available from FUTAMURA CHEMICAL CO., LTD.), KUREHA spherical activated carbon BAC (available from KUREHA CORPORATION), and fibrous activated carbon FR-20 (available from KURARAY CO., LTD.).

### —Carbon Nanotubes—

The carbon nanotube is a material in the form of a single-layer or multi-layer coaxial tube of a six-membered ring network (graphene sheet) formed of carbon.

The carbon nanotubes are not particularly limited and may be appropriately selected depending on the intended purpose. Examples of the carbon nanotubes include single-wall nanotubes (SWNT) and multiwall nanotubes (MWNT).

### —Mesoporous Silica—

The mesoporous silica is silica having pores. The average diameter of the pores is not particularly limited and may be appropriately selected depending on the intended purpose. The average diameter is preferably from 2 nm to 50 nm, and more preferably from 2 nm to 10 nm.

Typical examples of the mesoporous silica include MCM-41, MCM-48, MCM-50, SBA-1, SBA-11, SBA-15, SBA-16, FSM-16, KIT-5, KIT-6, HMS (hexagonal), MSU-F, and MSU-H. The above-listed examples of the mesoporous silica can be obtained for use by selecting from commercial product, or can be synthesized according to any of methods known in the art.

### —Porous Metal Complex—

The porous metal complex is a porous material including a metal ion and an anionic ligand. The porous metal complex is also referred to as a metal-organic framework (MOF) or a porous coordination polymer (PCP).

Examples of the metal ion include a titanium ion, a manganese ion, an iron ion, a cobalt ion, a nickel ion, a magnesium ion, a copper ion, a zinc ion, an aluminium ion, and a zirconium ion. The above-listed examples may be used alone or in combination.

Examples of the anionic ligand include anions listed below.
Halide ions, such as fluoride ions, chloride ions, bromide ions, and iodine ions.
Inorganic acid ions, such as tetrafluoroboric acid ions, hexafluorosilicic acid ions, hexafluorophosphoric acid ions, hexafluoroarsenic acid ions, and hexafluoroantimonic acid ions.
Sulfonic acid ions, such as trifluoromethanesulfonic acid ions, and benzene sulfonic acid ions.
Aliphatic monocarboxylic acid ions, such as formic acid ions, acetic acid ions, trifluoroacetic acid ions, propionic acid ions, butyric acid ions, isobutyric acid ions, valeric acid ions, caproic acid ions, enenthic acid ions, cyclohexanecarboxylic acid ions, caprylic acid ions, octylic acid ions, pelargonic acid ions, capric acid ions, lauric acid ions, myristic acid ions, pentadecylic acid ions, palmitic acid ions, margaric acid ions, stearic acid ions, tuberculostearic acid ions, arachidic acid ions, behenic acid ions, lignoceric acid ions, a-linolenic acid ions, eicosapentaenoic acid ions, docosahexanoic acid ions, linoleic acid ions, and oleic acid ions.
Aromatic monocarboxylic acid ions, such as benzoic acid ions, 2,5-dihydroxybenzoic acid ions, 3,7-dihydroxy-2-naphthoic acid ions, 2,6-dihydroxy-1-naphthoic acid ions, and 4,4′-dihydroxy-3-biphenylcarboxylic acid ions.
Heteroaromatic monocarboxylic acid ions, such as nicotinic acid ions and isonicotinic acid ions.
Aliphatic dicarboxylic acid ions, such as 1,4-cyclohexanedicarboxylate ions, and fumarate ions.
Aromatic dicarboxylic acid ions, such as 1,3-benzenedicarboxylate ions, 5-methyl-1,3-benzenedicarboxylate ions, 1,4-benzenedicarboxylate ions, 1,4-naphthalenedicarboxylate ions, 2,6-naphthalenedicarboxylate ions, 2,7-naphthalenedicarboxylate ions, and 4,4′-biphenyldicarboxylate ions.
Heteroaromatic dicarboxylic acid ions, such as 2,5-thiophenedicarboxylate ions, 2,2′-dithiophenedicarboxylate ions, 2,3-pyrazinedicarboxylate ions, 2,5-pyridinedicarboxylate ions, and 3,5-pyridinedicarboxylate ions.
Aromatic tricarboxylic acid ions, such as 1,3,5-benzenetricarboxylate ions, 1,3,4-benzenetricarboxylate ions, and biphenyl-3,4′,5-tricarboxylate ions.
Aromatic tetracarboxylic acid ions, such as 1,2,4,5-benzenetetracarboxylate ions, [1,1′:4′,1″]terphenyl-3,3″,5,5″-tetracarboxylate ions, and 5,5′(9,10-anthracenediyl)diisophthalate ions.
Ions of heterocyclic compounds, such as imidazolate ions, 2-methylimidazolate ions, and benzimidazolate ions.

In the present specification, the term “anionic ligand” means a ligand in which a site coordinated to a metal ion is anionic.

Among the above-listed examples, the anionic ligand is preferably an anionic ligand including a carboxylate group. Specifically, the anionic ligand is preferably at least one selected from the group consisting of aliphatic monocarboxylic acid ions, aromatic monocarboxylic acid ions, heteroaromatic monocarboxylic acid ions, aliphatic dicarboxylic acid ions, aromatic dicarboxylic acid ions, heteroaromatic dicarboxylic acid ions, aromatic tricarboxylic acid ions, and aromatic tetracarboxylic acid ions.

The porous metal complex may be produced for use or selected from commercial products. Moreover, examples of the porous metal complex include M₂(dobdc) complexes (M=Ni, Mg, Co, etc.) disclosed in the following literatures.
Literature: Dietzel, P. D. C.; Panella, B.; Hirscher, M.; Blom, R.; Fjellvag, H. Chem. Commun. 2006, 959.
Literature: Caskey, S. R.; Wong-Foy, A. G.; Matzger, A. J. J. Am. Chem. Soc. 2008, 130, 10870-10871.
Literature: Dietzel, P. D. C.; Besikiotis, V. Blom, R. J. Mater. Chem. 2009, 19, 7362-7370.
Literature: Liu, J.; Tian, J.; Thallapally, P. K.; McGrail, B. P. J. Phys. Chem. C 2012, 116, 9575-9581.

Examples of a production method of the porous metal complex include production methods disclosed in the following literature.
Literature: Ru-Qiang Zou, Hiroaki Sakurai, Song Han, Rui-Qin Zhong, and Qiang Xu, J. Am. Chem. Soc., 2007, 129, 8402-8403

Examples of the commercial products include a porous metal complex composed of an zinc ion and 2-methylimidazole [Basolite (registered trademark, which is the same hereinafter) Z1200, available from BASF SE], a porous metal complex composed of an aluminium ion and terephthalic acid (Basolite A100, available from BASF SE), a porous metal complex composed of a copper ion and trimesic acid (Basolite C300, available from BASF SE), a porous metal complex composed of an iron ion and trimesic acid (Basolite F300, available from BASF SE), and a porous metal complex composed of a copper ion, 4,4′-bipyridine, and tetrafluoroborate ([BF₄]⁻) (preELM-11, available from Tokyo Chemical Industry Co., Ltd.).

A method for disposing the adsorbent at a surface of the metal-containing member is not particularly limited and may be appropriately selected depending on the intended purpose. Examples of the method include a method where a coating material including the adsorbent is applied to the metal-containing member through coating, a method where the adsorbent itself is sprayed onto the metal-containing member, and a method where the adsorbent is sandwiched between the metal-containing member and the proton-permeable membrane.

The coating material used in the coating method includes at least the adsorbent, preferably further includes an ionic liquid, and may further include other components according to the necessity.

When the adsorbent and the ionic liquid are present together, the adsorbent easily receives protons passed through the proton-permeable membrane.

A ratio between the adsorbent and the ionic liquid in the coating material is not particularly limited and may be appropriately selected depending on the intended purpose.

Examples of the spraying method include aerosol deposition.

Examples of the cathode are explained with reference to drawings.

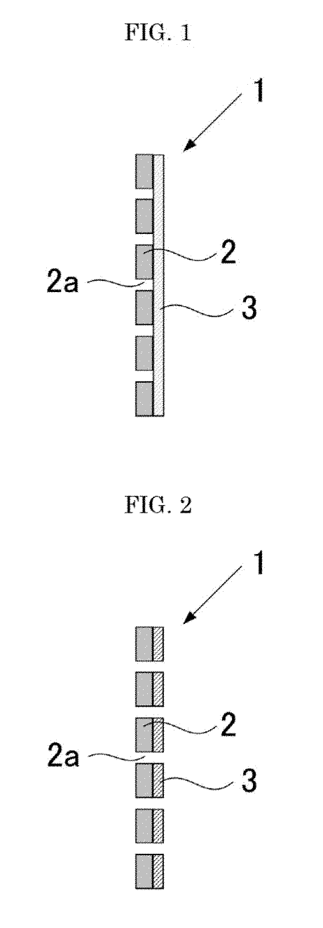

FIG. 1 is a schematic cross-sectional view illustrating one example of a cathode 1. In the cathode 1 of FIG. 1, an adsorbent 3 is disposed at a surface (single surface) of a metal-containing member 2 in the form of a layer.

The metal-containing member 2 has pores 2a through which carbon dioxide can pass in the thickness direction.

FIG. 2 is a schematic cross-sectional view illustrating another example of the cathode 1. In the cathode 1 of FIG. 2, an adsorbent 3 is disposed at a surface (single surface) of a metal-containing member 2.

The metal-containing member 2 has pores 2a through which carbon dioxide can pass in the thickness direction.

Differing from the cathode 1 of FIG. 1, the adsorbent 3 of the cathode 1 of FIG. 2 does not cover the pores 2a.

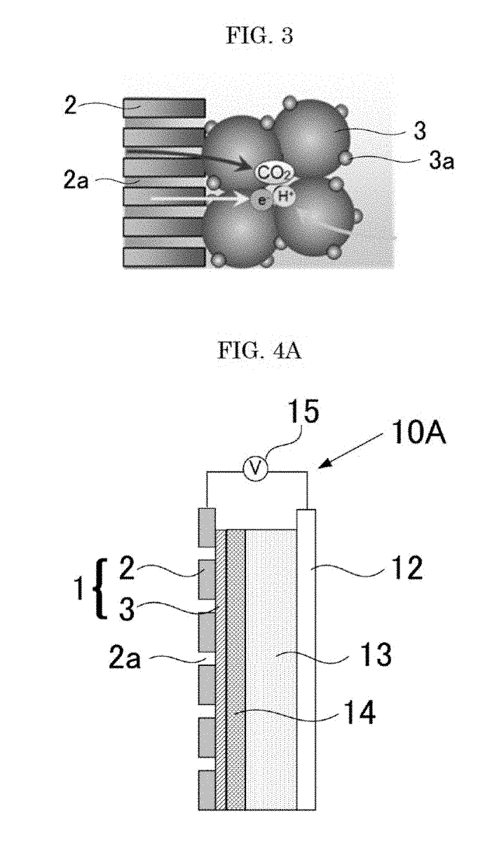

A state of a reduction reaction of carbon dioxide at a cathode is illustrated in FIG. 3.

Carbon dioxide reached to an adsorbent 3 through pores 2a of a metal-containing member 2 is allowed to react with an electron (e⁻) supplied from the metal-containing member 2 and a proton (H⁺) supplied from the side of a proton-permeable membrane to form a generated product, such as formic acid.

Since the adsorbent 3 has metal particles 3a at surfaces of grains of the adsorbent 3, an efficiency of transmitting electrons from the metal-containing member 2 is improved.

### <Other Members>

Examples of the above-mentioned other members include an electrolytic solution, a power source, and a light source.

### <<Electrolytic Solution>>

The electrolytic solution is retained in the liquid-retaining film.

Examples of the electrolytic solution include a potassium bicarbonate aqueous solution, a sodium bicarbonate aqueous solution, a sodium sulfate aqueous solution, a potassium chloride aqueous solution, a sodium chloride aqueous solution, and a sodium hydroxide aqueous solution.

A concentration of an electrolyte in the electrolytic solution is not particularly limited and may be appropriately selected depending on the intended purpose. The concentration is preferably 0.2 mol/L or greater, more preferably 1 mol/L or greater, and particularly preferably 2 mol/L or greater.

### <<Power Source>>

The power source is not particularly limited and may be appropriately selected depending on the intended purpose, as long as the power source is a member capable of applying direct current.

### <<Light Source>>

The light source is not particularly limited and may be appropriately selected depending on the intended purpose. Examples of the light source include a xenon lamp.

The light source is used for irradiating the anode with light in electrolytic reduction (so-called artificial photosynthesis) of carbon dioxide performed by applying light to the anode.

Examples of the disclosed carbon dioxide-reduction device will be explained with reference to drawings.

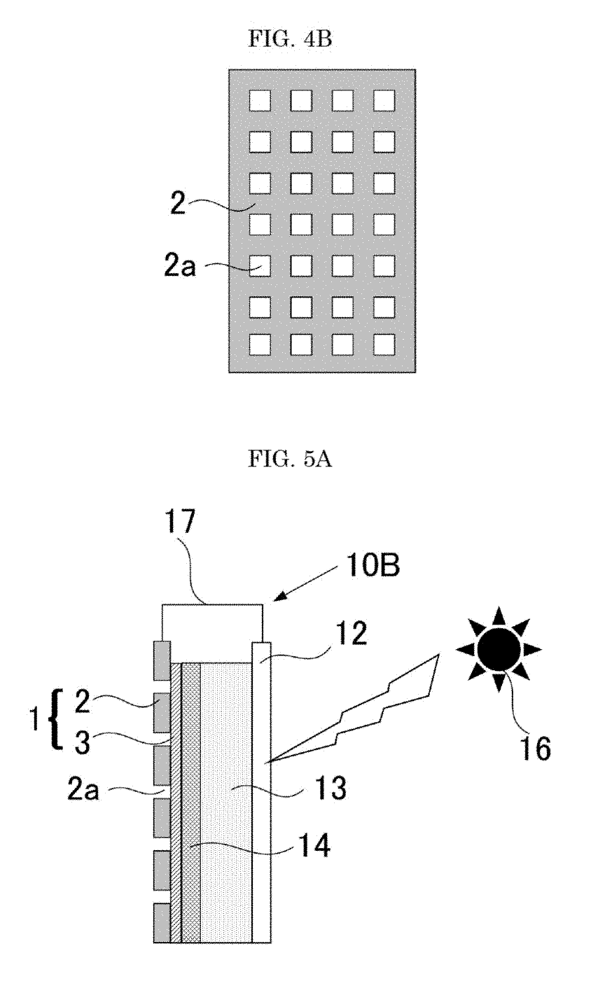

FIG. 4A is a schematic cross-sectional view of a carbon dioxide-reduction device 10A.

FIG. 4B is a left-side view of the carbon dioxide-reduction device 10A.

The carbon dioxide-reduction device 10A includes an anode 12, a liquid-retaining film 13, a proton-permeable membrane 14, and a cathode 1 in this order. The carbon dioxide-reduction device 10A further includes a constant-voltage power supply 15.

In the cathode 1, an adsorbent 3 is disposed at a surface (single surface) of a metal-containing member 2 in the form of a layer. The metal-containing member 2 has pores 2a through which carbon dioxide can pass in the thickness direction.

The anode 12 is in contact with the liquid-retaining film 13, the liquid-retaining film 13 is in contact with the proton-permeable membrane 14, and the proton-permeable membrane 14 is in contact with the adsorbent 3 of the cathode 1.

Areas of the anode 12, the liquid-retaining film 13, the proton-permeable membrane 14, and the cathode 1 are substantially the same, and any of the above-mentioned members is not significantly larger than the others.

An electrolytic solution is retained in the liquid-retaining film 13.

In the carbon dioxide-reduction device 10A, voltage is applied between the cathode 1 and the anode 12 by the constant-voltage power supply 15. As a result, oxidative degradation of water occurs at the side of the anode. Meanwhile, reduction of carbon dioxide occurs at the side of the cathode. At the side of the cathode, carbon dioxide is retained on or above a surface of the metal-containing member 2 owing to a function of the adsorbent 3. Accordingly, reduction of carbon dioxide is efficiently performed.

Since the electrolytic solution is retained in the liquid-retaining film 13, moreover, an amount of carbon dioxide dissolved in the electrolytic solution and an amount of the generated product dissolved in the electrolytic solution are small. In addition, since the electrolytic solution and the adsorbent are prevented from being in contact with each other by the proton-permeable membrane 14, the permeation of the electrolytic solution into pores of the adsorbent can be prevented. Furthermore, the metal-containing member 2 has pores 2a. Accordingly, supplement of carbon dioxide to a reaction field and collection of a generated product from the reaction field can be efficiently performed.

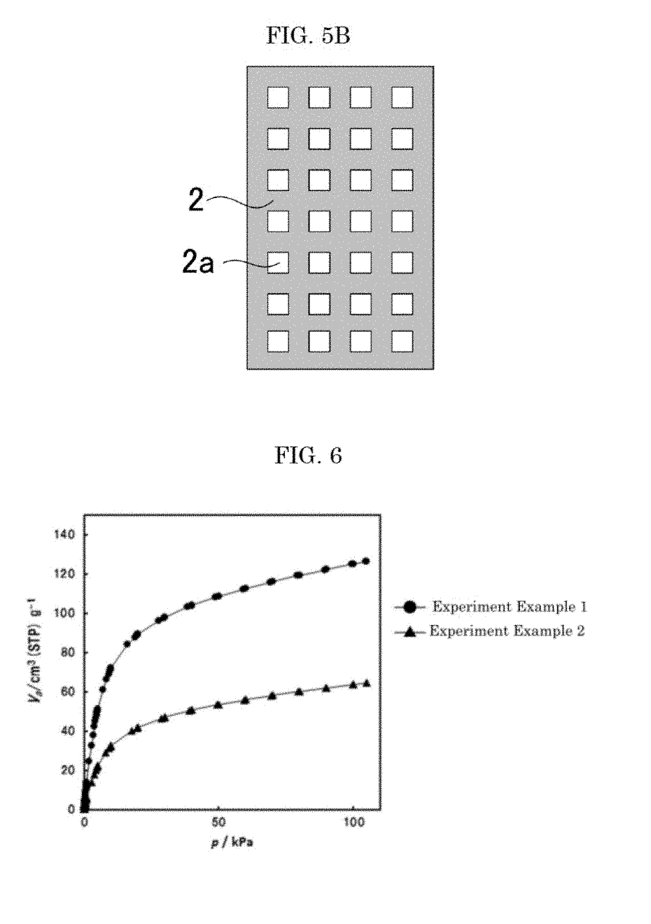

FIG. 5A is a schematic cross-sectional view of a carbon dioxide-reduction device 10B.

FIG. 5B is a left-side view of the carbon dioxide-reduction device 10B.

The carbon dioxide-reduction device 10B includes an anode 12, a liquid-retaining film 13, a proton-permeable membrane 14, and a cathode 1 in this order. Moreover, the carbon dioxide-reduction device 10B includes a light source 16.

In the cathode 1, an adsorbent 3 is disposed at a surface (single surface) of a metal-containing member 2 in the form of a layer. The metal-containing member 2 has pores 2a through which carbon dioxide can pass in the thickness direction.

The anode 12 is in contact with the liquid-retaining film 13, the liquid-retaining film 13 is in contact with the proton-permeable membrane 14, and the proton-permeable membrane 14 is in contact with the adsorbent 3 of the cathode 1.

Areas of the anode 12, the liquid-retaining film 13, the proton-permeable membrane 14, and the cathode 1 are substantially the same, and any of the above-mentioned members is not significantly larger than the others.

An electrolytic solution is retained in the liquid-retaining film 13.

The anode 12 is a photochemical electrode for reducing carbon dioxide.

In the carbon dioxide-reduction device 10B, oxidative degradation of water occurs at a surface of the anode 12 when light is applied to the anode 12 from the light source 16. As a result of the reaction, electromotive force is generated between the anode 12 and the cathode 1 coupled with a conducting wire 17. The electromotive force induces reduction of carbon dioxide at the side of the cathode. At the side of the cathode, carbon dioxide can be retained on or above a surface of the metal-containing member 2 by a function of the adsorbent 3. Therefore, reduction of carbon dioxide can be performed efficiently.

Since the electrolytic solution is retained in the liquid-retaining film 13, moreover, an amount of carbon dioxide dissolved in the electrolytic solution and an amount of the generated product dissolved in the electrolytic solution are small. In addition, since the electrolytic solution and the adsorbent are prevented from being in contact with each other by the proton-permeable membrane 14, the permeation of the electrolytic solution into pores of the adsorbent can be prevented. Furthermore, the metal-containing member 2 has pores 2a. Accordingly, supplement of carbon dioxide to a reaction field and collection of a generated product from the reaction field can be efficiently performed.

### EXAMPLES

The disclosed technique will be described hereinafter, but the disclosed technique should not be construed as being limited to Examples below.

### Experiment Example 1

A Ni₂(dobdc) complex (adsorbent) was synthesized and evaluated as a porous metal complex having CO₂ adsorption ability.

A THF solution of 2,5-dihydroxyterephthalic acid and an aqueous solution of nickel acetate tetrahydrate were mixed, and the mixture was heated for 3 days at 110° C. by the solvothermal method to yield yellow powder (a powder sample). The synthesis was performed with reference to the literature (Liu, J.; Tian, J.; Thallapally, P. K.; McGrail, B. P. J. Phys. Chem. C 2012, 116, 9575-9581.).

The CO₂ adsorption properties of the powder sample were measured by means of a gas/vapor adsorption measuring device (available from MicrotracBEL Corp.). As a result, the adsorption isotherm of FIG. 6 was obtained.

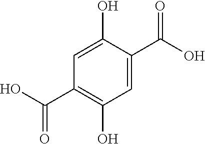 [SMILES: O=C(O)c1cc(O)c(C(=O)O)cc1O]

### Experiment Example 2

Onto surfaces of grains of the powder sample, which was the Ni₂(dobdc) complex synthesized in Experiment Example 1, 2% by mass equivalent of copper particles were born according to the following reduction precipitation method.

An acetyl acetone complex of copper [Cu(acac)₂] was dissolved in 2-propanol, the Ni₂(dobdc) complex was suspended in the solution, and to the resultant, sodium borohydride was added, followed by heating and stirring the mixture for 30 minutes at 85° C., to reduce Cu(acac)₂ and precipitate metal copper on the surfaces of the grains of the Ni₂(dobdc) complex powder. As a result, a powder sample (adsorbent, powder where copper particles were born on the Ni₂(dobdc) complex) was obtained.

The reduction precipitation method was performed with reference to the literature (Masakazu Iwamoto et al., Catalyst preparation handbook (NTS), 70 (2011)).

The CO₂ adsorption properties of the obtained powder sample were measured by means of the gas/vapor adsorption measuring device. As a result, the adsorption isotherm of FIG. 6 was obtained. The adsorption was reduced by about a half compared to Experiment Example 1, but it was confirmed that the powder sample had CO₂ adsorption ability.

### Example 1

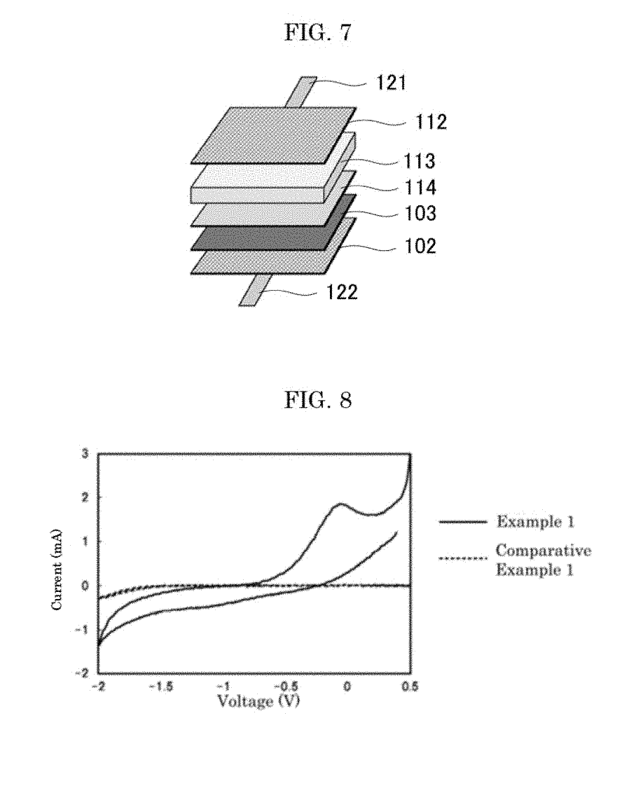

A carbon dioxide-reduction device illustrated in FIG. 7 was produced, and electrolytic reduction behavior of CO₂ was evaluated by an electrochemical method.

Materials used for the device are listed below.
Anode 112: a mesh platinum electrode
Liquid-retaining film 113:
   A porous body (polyvinyl alcohol porous body, PVA sponge, available from AION Co., Ltd.) to which 0.5 M of Na₂SO₄ was absorbed
Proton-permeable membrane 114: NAFION film (available from Sigma-Aldrich Co., LLC.)
Adsorbent layer 103: average thickness (300 μm)
Metal-containing member 102: a mesh copper electrode
   Material: copper
   Mesh: 40 (the number of divisions within 25.4 mm)
   Line diameter: 0.22 mm
   Area: 35 mm×25 mm
Counter electrode 121: a copper foil
Working electrode 122: a copper foil

The adsorbent layer 103 was produced by adding an ionic liquid [1-butyl-3-methylimidazoliumbis(trifluoromethanesulfonyDimide, available from Tokyo Chemical Industry Co., Ltd.] to the powder sample (adsorbent, powder where copper particles were born on the Ni₂(dobdc) complex) produced in Experiment Example 2, kneading the mixture, and applying the kneaded product onto the mesh copper electrode.

On the produced adsorbent layer 103, the proton-permeable membrane 114, the liquid-retaining film 113, and the anode 112 were disposed in this order. The counter electrode 121 was coupled with the anode 112, and the working electrode 122 was coupled with the metal-containing member 102.

In the manner described above, the carbon dioxide-reduction device was obtained.

After placing the carbon dioxide-reduction device in the CO₂ atmosphere for 30 minutes, cyclic voltammetry was measured. The result is depicted in FIG. 8.

### Comparative Example 1

A carbon dioxide-reduction device was produced in the same manner as in Example 1, except that the adsorbent layer was not disposed.

After placing the carbon dioxide-reduction device in the CO₂ atmosphere for 30 minutes, cyclic voltammetry was measured. The result is depicted in FIG. 8.

It was confirmed by comparing between Example 1 and Comparative Example 1 that oxidation-reduction current was increased in Example 1 and the carbon dioxide supplied from the side of the mesh copper electrode was efficiently reacted by the function of the adsorbent.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the sprit and scope of the invention.

What is claimed is:

1. A carbon dioxide-reduction device comprising:
an anode;
a liquid-retaining film capable of retaining an electrolytic solution;
a proton-permeable membrane; and
a cathode,
wherein the cathode includes a metal-containing member and an adsorbent,
where the metal-containing member includes a metal capable of reducing carbon dioxide and has pores through which carbon dioxide can pass in a thickness direction of the metal-containing member, and
the adsorbent is capable of adsorbing carbon dioxide, and is disposed at a surface of the metal-containing member at a side of which the proton-permeable membrane is present.

2. The carbon dioxide-reduction device according to claim 1,
wherein the metal includes copper, silver, gold, zinc, or indium.

3. The carbon dioxide-reduction device according to claim 1,
wherein the adsorbent includes activated carbon, carbon nanotubes, mesoporous silica, or a porous metal complex.

4. The carbon dioxide-reduction device according to claim 1,
wherein the adsorbent is a porous metal complex.

5. The carbon dioxide-reduction device according to claim 1,
wherein the adsorbent includes metal particles at surfaces of grains of the adsorbent.

6. The carbon dioxide-reduction device according to claim 5,
wherein the metal particles are copper, silver, gold, zinc, or indium.

7. The carbon dioxide-reduction device according to claim 1,
wherein the anode has pores through which gas can pass in a thickness direction of the anode.
